(19) United States
(12) Patent Application Publication
(10) Pub. No.: US 2024/0183872 A1
(43) Pub. Date: Jun. 6, 2024

(54) DIAGNOSTIC INSTRUMENTS HAVING SORTING CAPABILITY AND SORTING METHODS THEREOF

(71) Applicant: Siemens Healthcare Diagnostics Inc., Tarrytown, NY (US)

(72) Inventors: Muhammad Ahmed, Yonkers, NY (US); Hadi Arbabi, New York, NY (US); Shane Manning, Mount Vernon, NY (US); Navneet Jain, Mahwah, NJ (US)

(73) Assignee: Siemens Healthcare Diagnostics Inc., Tarrytown, NY (US)

(21) Appl. No.: 18/553,166

(22) PCT Filed: Mar. 25, 2022
(86) PCT No.: PCT/US2022/071366

§ 371 Date: Sep. 28, 2023

Related U.S. Application Data
(60) Provisional application No. 63/169,372, filed on Apr. 1, 2021.

(51) Int. Cl. G01N 35/00; G01N 35/04

(52) U.S. Cl. CPC G01N 35/00871; G01N 35/0092; G01N 2035/0406

(57) ABSTRACT

Diagnostic instruments and methods of operating diagnostic instruments are provided. Methods of operating a diagnostic instrument includes providing the diagnostic instrument having one or more modules, wherein the one or more modules are configured to analyze specimens; providing a specimen sorter coupled to the diagnostic instrument; and sorting specimens into at least first group and a second group, wherein specimens in the first group are to be analyzed by at least one of the one or more modules, and specimens in the second group are not to be analyzed by any of the one or more modules. Other sorting methods and diagnostic instruments are provided.

### CROSS REFERENCE TO RELATED APPLICATION

This application claims the benefit of U.S. Provisional Patent Application No. 63/169,372, entitled “DIAGNOSTIC INSTRUMENTS HAVING SORTING CAPABILITY AND SORTING METHODS THEREOF” filed Apr. 1, 2021, the disclosure of which is hereby incorporated by reference in its entirety for all purposes.

### FIELD

Embodiments of this disclosure relate to diagnostic instruments and operating methods thereof.

### BACKGROUND

Diagnostic laboratory systems analyze biological specimens, such as whole blood, blood serum, blood plasma, urine, interstitial liquid, cerebrospinal liquid, and the like, to identify analytes or other constituents in the specimens. Some diagnostic laboratory systems may include a plurality of modules and instruments that perform prescreening and analyses of the specimens. Some diagnostic laboratory systems may include hundreds of modules and instruments and may perform thousands of analyses per day.

The specimens are usually contained within specimen containers (e.g., specimen collection tubes). The specimen containers are delivered to a diagnostic laboratory system and are then sorted by the tests to be performed on the specimens. The specimen containers and/or the specimens are then transported to the appropriate modules and/or instruments for prescreening and testing. For example, the specimen containers can be transported via an automated track system to one or more pre-processing modules, pre-screening modules, and analyzers (e.g., immunoassay and/or clinical chemistry) within the diagnostic laboratory system.

One of the time-consuming processes performed within diagnostic laboratory system is the sorting process. The sorting process may be performed manually by operators or by designated sorting machines. In some embodiments, the sorting process may sort the specimen containers based on specific analyses that are to be performed on the specimens, which can take a significant amount of time. In addition, should a sorting machine experience a fault, the diagnostic laboratory analyzer may not be able to perform any analyses or the efficiency of the laboratory analyzer may be reduced.

Based on the foregoing improvements in sorting specimens and specimen containers in diagnostic laboratory systems are sought.

### SUMMARY

According to a first aspect, a method of operating a diagnostic instrument is provided. The method includes providing a diagnostic instrument having one or more modules, wherein the one or more modules are configured to analyze specimens; providing a specimen sorter coupled to the diagnostic instrument; and sorting specimens into at least a first group and a second group using the specimen sorter, wherein specimens in the first group are to be analyzed in at least one of the one or more modules, and specimens in the second group are not to be analyzed in any of the one or more modules.

In another aspect, a method of operating a diagnostic instrument is provided. The method includes providing a diagnostic instrument having one or more modules, wherein the one or more modules are configured to analyze and/or process specimen containers and/or specimens contained in the specimen containers; providing a specimen sorter coupled to the diagnostic instrument; and sorting specimen containers into at least a first group and a second group, specimen containers or specimens in the first group to be analyzed or processed by at least one of the one or more modules, and specimen containers or specimens in the second group not to be analyzed or processed by any of the one or more modules.

In another aspect, a diagnostic instrument is provided. The diagnostic instrument includes one or more modules; a specimen sorter configured to sort specimens into at least a first group and a second group, wherein specimens in the first group are to be analyzed by at least one of the one or more modules, and specimens in the second group are not to be analyzed by any of the one or more modules; and a transport system interconnecting the specimen sorter and at least one of the one or more modules, the transport system being configured to move specimens in the first group to at least one of the one or more modules.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure. This disclosure is intended to cover all modifications, equivalents, and alternatives falling within the scope of the claims.

### BRIEF DESCRIPTION OF THE DRAWINGS

The drawings, described below, are for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1 illustrates a schematic block diagram of a diagnostic laboratory system including a plurality of modules and diagnostic instruments, wherein at least one diagnostic instrument is configured to sort specimen containers according to one or more embodiments of the present disclosure.

FIG. 2A illustrates a side elevation view of a specimen container located in a carrier, the specimen container containing a specimen separated into at least a serum or plasma portion and a settled blood portion according to one or more embodiments of the disclosure.

FIG. 2B illustrates a side elevation view of a specimen container located in a carrier, the specimen container containing an unseparated specimen according to one or more embodiments of the disclosure.

FIG. 2C illustrates a side elevation view of a specimen container removed from a carrier, the specimen container containing an unseparated specimen according to one or more embodiments.

FIG. 3 illustrates a schematic diagram of an instrument of a diagnostic laboratory system including a specimen sorter according to one or more embodiments of the disclosure.

FIGS. 4A and 4B are a flowchart illustrating a method of operating a diagnostic laboratory system that includes an instrument wherein the instrument includes a specimen sorter according to one or more embodiments of the disclosure.

FIG. 5 is a flowchart illustrating a method of operating a diagnostic instrument according to one or more embodiments.

FIG. 6 is a flowchart illustrating another method of operating a diagnostic instrument according to one or more embodiments.

### DETAILED DESCRIPTION

Diagnostic laboratory systems may include one or more modules and/or diagnostic instruments that perform processes, prescreening, and/or analyses on specimen containers and/or specimens located in the specimen containers. Examples of individual modules and/or modules in diagnostic instruments configured to processes specimen containers include input/output (I/O) loaders and decappers. Other specimen container processing modules may be used. Examples of individual modules and/or modules in diagnostic instruments configured to process or prescreen specimens prior to testing include centrifuges, quality control modules, and aliquoters. Examples of modules and/or modules in diagnostic instruments configured to analyze specimens include diagnostic analyzers (sometimes referred to herein simply as “analyzers”) that identify and/or analyze one or more analytes within the specimens. For example, some diagnostic analyzers may perform one or more clinical chemical analysis, other diagnostic analyzers may perform one or more immunoassays, and other diagnostic analyzers may perform one or more other functions, such as genetic analyses or drug analyses.

The diagnostic laboratory systems may include a transport system such as a track or the like that transports specimen containers between the different modules and/or the instruments. Thus, a diagnostic laboratory system may include a plurality of modules and/or diagnostic instruments with the track extending between the modules and the diagnostic instruments.

A medical professional may order certain analyses (e.g., test orders) to be performed on certain specimens (e.g., liquids) taken from a patient. These test orders may be entered into a program or server, such as a hospital information system (HIS). The test orders then may be transmitted from the HIS to a laboratory information system (LIS) that receives a plurality of test orders and generates, possibly with the assistance of I/O loader logic, testing protocols and/or scheduling for the diagnostic laboratory system to complete the test orders. The test orders may come from sources other than a HIS in some cases.

The specimen containers containing the specimens may be physically sent to a diagnostic laboratory system and the test orders may be electronically transmitted to the diagnostic laboratory system. Several medical professionals may simultaneously generate test orders that are to be performed using a diagnostic laboratory system. Accordingly, many specimen containers and test orders may be received at the diagnostic laboratory system. One of the first steps performed by the diagnostic laboratory system is sorting the specimen containers. The sorting may be very time consuming and costly given the high number of test orders that may be received by diagnostic laboratory system. The sorting may be performed manually by an operator (user) or by an automated sorting system. In some diagnostic laboratory systems, a single module is dedicated solely to sorting specimen containers. The single module may place specimen containers requiring like analyses into the same racks during the sorting processes.

The sorting may be very time consuming and very expensive. For example, a module, which may be very expensive, may be dedicated solely to sorting specimen containers or an employee may be paid to sort specimen containers. The module may malfunction, which may reduce the number of specimens that the diagnostic laboratory system may analyze. The manual sorting may be subject to human error.

The methods and apparatus described herein provide diagnostic instruments having one or more specimen sorters coupled to the diagnostic instruments. The diagnostic instruments also include one or more modules configured to analyze and/or process specimens and/or specimen containers. In some embodiments, a specimen sorter may be a module of the diagnostic instrument. In some embodiments, a specimen sorter may be implemented in another module, such as a specimen handling module of a diagnostic instrument. The specimen sorter or a component of a diagnostic instrument may identify the specimen containers, such as by reading information or indicia located on the specimen containers. The diagnostic instrument may then request information regarding a specimen state, which may include testing (e.g., analyses) and/or processes that are to be performed on the specimens. In some embodiments, the diagnostic instrument may request the state of testing of the specimen from a LIS or the like.

In some embodiments, the specimen sorters may sort the specimen containers or the specimens into at least a first group and a second group. The first group may include specimens that are to be analyzed or processed by at least one of the one or more modules of the diagnostic instrument. The second group may include specimens that are not to be analyzed or processed by at least one of the one or more modules of the diagnostic instrument. In some embodiments, the first group may include specimen containers that are to be processed or analyzed by at least one of the one or more modules in the diagnostic instrument. In such embodiments, the second group may include specimen containers that are not to be processed or analyzed by at least one of the one or more modules in the diagnostic instrument.

In some embodiments, the specimen containers may be sorted such that specimen containers containing specimens that are to have additional testing performed by other diagnostic instruments may be grouped together. Specimen containers containing specimens that are finished with testing may be grouped together. Specimen containers containing specimens that do not have any testing status may be grouped together. Other sorting configurations may be used.

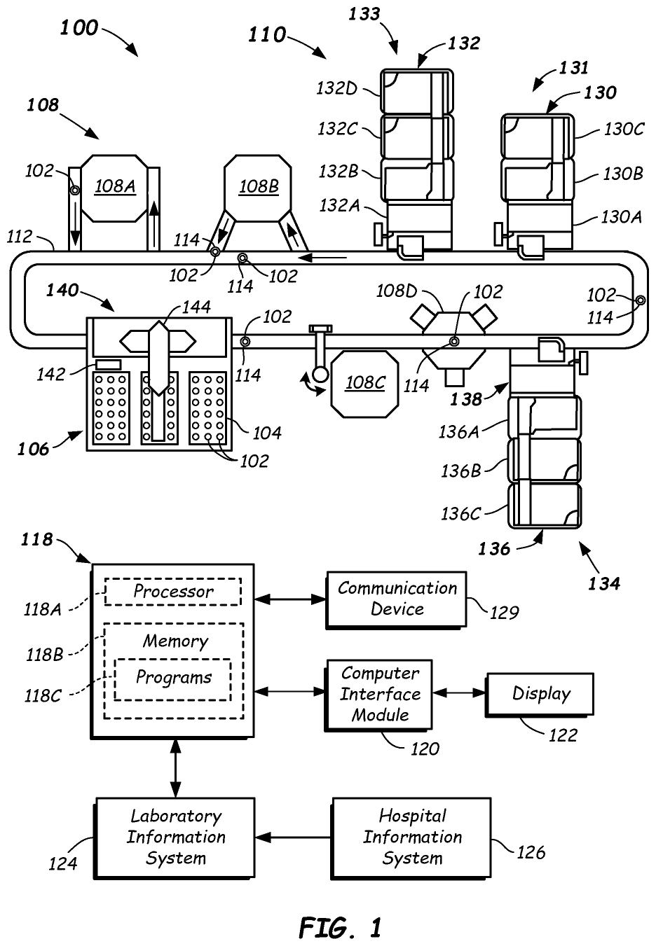

These and other apparatus, diagnostic laboratory systems, instruments, and methods are described in greater detail with reference to FIGS. 1-6 herein.

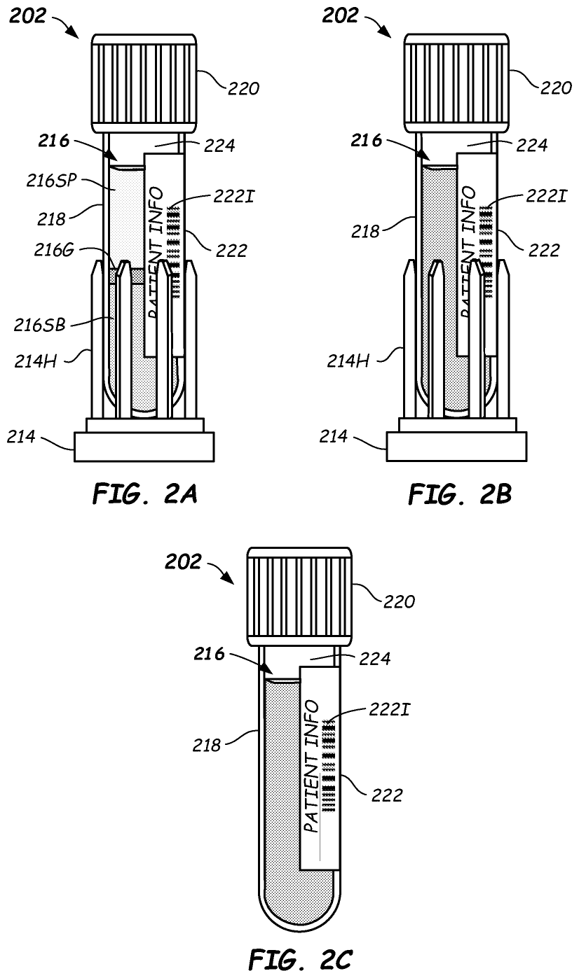

Reference is now made to FIG. 1, which illustrates an example embodiment of an automated diagnostic analysis system 100 configured to process and/or analyze biological specimens stored in specimen containers 102. The specimen containers 102 may be received at the system 100 in one or more racks 104 provided at a loading area 106. The specimen containers 102 may be transported throughout the system 100, such as to and from modules 108 and instruments 110 by way of a track 112 by carriers 114. The carriers 114 may be configured to transport the specimen containers 102 in a vertical orientation throughout the system 100 (see FIGS. 2A and 2B).

The diagnostic laboratory system 100 may include a computer 118 or be configured to communicate with an external computer. The computer 118 may be a microprocessor-based central processing unit CPU with suitable memory, software, and conditioning electronics and drivers for operating the various components, modules 108, and instruments 110 of the system 100. The computer 118 may include a processor 118A and memory 118B, wherein the processor 118A is configured to execute programs 118C stored in the memory 118B. The computer 118 may be housed as part of, or separate from, the system 100. The programs 118C may operate components of the system 100 and may operate the modules 108 and/or instruments 110 as described herein.

The computer 118, by way of the programs 118C, may control movement of the carriers 114 to and from the loading area 106, about the system track 112, to and from the modules 108 and the instruments 110, and to and from other modules and components of the system 100. The operation of each of the modules 108, the instruments 110, and other components and modules may be performed by the computer 118. In some embodiments, the operation of each of the modules 108, the instruments 110, and other components and modules may be at least partially performed by local workstation computers (not shown) at one or more of the modules 108 and/or instruments 110. One or more of the workstations may be in communication with the computer 118 through a network, such as a local area network (LAN), wide area network (WAN), or other suitable communication network, including wired and wireless networks.

In some embodiments, the computer 118 may be coupled to a computer interface module (CIM) 120. The CIM 120 and/or the computer 118 may be coupled to a display 122. The CIM 120, in conjunction with the display 122, enables a user to access a variety of control and status display screens and to input data into the computer 118. These control and status display screens may display and enable control of some or all aspects of the modules 108 and/or instruments 110 used for preparation, pre-screening, and analysis of specimen containers 102 and/or the specimens located therein. Thus, the CIM 120 may be adapted to facilitate interactions between a user and the system 100. In some embodiments, the display 122 may be configured to display a menu including icons, scroll bars, boxes, and buttons through which the user may interface with the diagnostic laboratory system 100. The menu may comprise a number of functional elements programmed to display and/or operate functional aspects of the diagnostic laboratory system 100.

The diagnostic laboratory system 100 may include a laboratory information system (LIS) 124 that is configured to schedule testing on the modules 108, the instruments 110, and/or other components. In some embodiments, the LIS 124 may be implemented in the computer 118. In some embodiments, the LIS 124 may be located and operated separately from the diagnostic laboratory system 100. The LIS 124 may be in communication with a hospital information system (HIS) 126 that may be configured to receive test orders from medical providers and the like. In some embodiments, the HIS 126 may be implemented in the computer 118, the LIS 124, and/or another computer.

In the embodiment of FIG. 1, the diagnostic laboratory system 100 includes a first instrument 131, a second instrument 133, and a third instrument 134 that may each include a plurality of modules therein. The first instrument 131 may include three modules 130A-130C, wherein one or more of the modules 130A-130C may perform functions similar to or identical to the modules 108 as described herein. The second instrument 133 may include four modules 132A-132D, wherein one or more of the modules 132A-132D may perform functions similar to or identical to the modules 108 as described herein. The third instrument 134 may include a plurality of modules 136, that are referred to individually as a first module 136A, a second module 136b, and a third module 136C. The third instrument 134 may also include a specimen sorter 138 as described herein. In some embodiments, the specimen sorter 138 may be one of the modules 136. A specimen sorter is a device that is configured to sort specimens and/or specimen containers 102 into two or more pre-selected groups as is described herein.

In some embodiments, the first module 130A of the first instrument 131 and the first module 132A of the second instrument 133 may be or may include specimen sorters. The remaining modules 130B-130C of the first instrument 131 and the remaining modules 132B-132D of the second instrument may be preprocessing modules, analyzers, and/or other modules configured to analyze or process specimens and/or the specimen containers 102. Other ones of the modules 130 and the modules 132 may be specimen sorters.

In the embodiment of FIG. 1, the diagnostic laboratory system 100 includes four modules 108, which are referred to individually as a first module 108A, a second module 108B, a third module 108C, and a fourth module 108D. The diagnostic laboratory system 100 may include other modules and components (not shown) that perform specific functions and/or processes. At least one of the modules 108 may perform preprocessing functions and may include a decapper and/or a centrifuge, for example. In some embodiments, one or more of the modules 108 may be one or more clinical chemistry analyzers and/or one or more assaying instruments, or the like, or combinations thereof. Some of the modules 130, 132, 136 of the instruments 110 may perform identical or similar functions as the modules 108.

The modules 108 may include machines that are configured to prepare and/or process the specimen containers 102 and/or specimens located therein for testing at one or more instruments 110. In some embodiments, the modules 108 may prepare the specimen containers 102 and/or the specimens to be received and/or tested by the analyzer modules. In the embodiment of FIG. 1, the modules 108 may include machines such as an input/output (I/O) loader, a desealer, a centrifuge, and a quality check (QC) station. The diagnostic laboratory system 100 may include other or fewer modules. In the embodiment of FIG. 1, the diagnostic laboratory system 100 may have redundant modules to handle high test volumes and to enable testing in the event one or more of the modules 108 or instruments 110 become nonfunctional or disabled.

The diagnostic testing performed by one or more of the modules 108 configured as analyzers may include, but are not limited to, immunoassay testing (e.g., chemiluminescent immunoassays (CLIA), radioimmunoassays (RIA), counting immunoassays (CIA), fluoroimmunoassays (FIA), and enzyme immunoassays (EIA and including enzyme linked immunosorbent assays (ELISA)) to target specific target biomolecules. In addition, some of the modules 108 may measure concentrations of substances or analytes, such as glucose, hemoglobin A1C, lipids (fats), triglycerides, blood gases (e.g., carbon dioxide, etc.), enzymes, electrolytes (e.g., sodium, potassium, chloride, and bicarbonate), lipase, bilirubin, creatinine, blood urea nitrogen (BUN), hormones (e.g., thyroid stimulating hormone), hepatitis, minerals (e.g., iron. calcium, magnesium, etc.), proteins, and other metabolic products and the like in the specimens. Other testing may be performed on the specimens by the modules 108. The specimens can include whole blood, serum, plasma, urine, cerebral-spinal fluid, interstitial fluid, saliva, feces, and the like. The modules 130, 132, 136 of the instruments 110 may perform identical or similar functions as the modules 108 described herein.

In some embodiments, two or more of the modules 108, including the modules 130, 132, 136, may be capable of performing the same tests (i.e., they have the same or overlapping test menus), while others of the modules 108 may be capable of performing only a limited number of tests or only certain individual tests. Thus, in some embodiments, the modules 108, 130, 132, 136 may be configured to run the same or overlapping tests, which enable the diagnostic laboratory system 100 to handle high test volumes, perform redundant testing, and continue testing in the event a module becomes nonfunctional or disabled.

Additional reference is made to FIGS. 2A-2C, which illustrates embodiments of a specimen container 202 with a specimen 216 located therein. The specimen container 202 may be representative of the specimen containers 102 (FIG. 1) and the specimen 216 may be representative of specimens located in the specimen containers 102. The specimen container 202 may include a tube 218 and may be capped with a cap 220. Caps 220 on different specimen containers may be of different types and/or colors (e.g., red, royal blue, light blue, green, grey, tan, yellow, or color combinations), which may have meaning in terms of tests the specimen container 202 is used for, the type of additive included therein, whether the container includes a gel separator 216G, and the like. Other colors may be used to denote other functionalities.

The specimen container 202 may be provided with at least one label 222 that may include identification information 2221 (i.e., indicia) thereon, such as a barcode, alphabetic characters, numeric characters, or combinations thereof. The identification information 2221 may include or be associated with data stored in or accessible by the LIS 124, such as a database in the LIS 124. The database may include patient information, such as name, date of birth, address, and/or other personal information. The database may also include tests to be performed, time and date the specimen 216 was obtained, and/or medical facility information. The database may also include tracking and routing information, including which tests have been performed on the specimen 216 and which tests need to be performed on the specimen 216. Other relevant information may also be included.

The identification information 2221 may be machine readable at various locations throughout the diagnostic laboratory system 100. The machine readable information may be darker (e.g., black) than the label material (e.g., white paper) so that the identification information 2221 can be readily imaged (e.g., read). The identification information 2221 may indicate, or may otherwise be correlated, via the LIS 124 or other test ordering systems, to a patient's identification as well as tests to be performed on the specimen 216. The identification information 2221 may be provided on the label 222, which may be adhered to or otherwise provided on an outside surface of the tube 218.

The specimen 216 illustrated in FIG. 2A has undergone a centrifuge process, such as in one of the modules 108, and may include a serum or plasma portion 216SP and a settled blood portion 216SB contained within the tube 218. A gel separator 216G may be located between the serum or plasma portion 216SP and the settled blood portion 216SB. Air 224 may be located above the serum and plasma portion 216SP.

The embodiment of FIGS. 2A-2B illustrates a side elevation view of the specimen container 202 located in a carrier 214. The carrier 214 may be representative of the carriers 114 (FIG. 1). The carrier 214 may include a holder 214H configured to hold the specimen container 202 in a defined upright position. The holder 214H may include a plurality of fingers or leaf springs that secure the specimen container 202 in the carrier 214. Some of the fingers or leaf springs may be moveable or flexible to accommodate different sizes (widths) of the specimen container 202. In some embodiments, the carrier 214 may leave from the loading area 106 (FIG. 1) after being loaded with the specimen container 202. FIG. 2C illustrates the specimen container 202 removed from the carrier 214.

Referring again to FIG. 1, the computer 118 may be in communication with a communication device 129 that enables communications between the computer 118 and the modules 108 and the instruments 110. The communication device 129 may provide wireless communications (e.g., radio frequency (RF) or optical communications) and/or wired communications between the computer 118, the modules 108, the instruments 110, and other components of the diagnostic laboratory system 100. The communications device 129 may enable data measured by the modules 108 and the instruments 110 to be transmitted to the computer 118. The communications device 129 may also enable the computer 118 to transmit instructions, such as operating instructions, to the modules 108 and the instruments 110.

In some embodiments, diagnostic laboratory system 100 may include an I/O loader 140 located proximate the track 112 and the loading area 106. The I/O loader 140 may include a robot 144 configured to load the specimen containers 102 onto the track 112 and may remove the specimen containers 102 from the track 112. For example, robot 144 may place the specimen containers 102 into the carriers 114 and remove the specimen containers 102 from the carriers 114. The robot 144 or other device may also sort the specimen containers 102 into specific ones of the racks 104 as described herein. The I/O loader 140 and the components therein, including the robot 144, may be in communication with the computer 118, such as via the communication device 129.

In some embodiments, the I/O loader 140 may include components 142 that are configured to read labels (e.g., label 222—FIGS. 2A-2B), such as identification information (e.g., identification information 2221—FIGS. 2A-2B) on the specimen containers 102. In some embodiments, the identification information 2221 may be a barcode and the components 142 may include a barcode reader configured to read the barcode. In some embodiments, the label 222 may include identification information thereon, such as, a time and/or date stamp, requested test(s), patient identification, and the like.

When the identification information 2221 is read, such as by one or more of the components 142, data representative of the identification information 2221 may be transmitted to the computer 118, such as via the communication device 129. One or more of the programs 118C executable by the computer 118 may receive the information read from the label 222 and, based on the information and internal logic, determine the tests to be conducted on the specimen 216. For example, the HIS 126 may transmit the test orders to the LIS 124. The LIS 124 may provide the test orders to the one or more programs 118C in response to the test orders received from the HIS 126. In some embodiments, the LIS 124 or logic of the I/O loader 140 may determine processes and tests that need to be performed on the specimen containers 102 and/or the specimens (e.g., specimen 216) located therein and may determine the modules 108 and/or instruments 110 that are to be used to perform the processes and tests.

The programs 118C may transmit instructions to the robot 144 that instruct the robot 144 to place specific ones of the specimen containers 102 in specific ones of the racks 104 or specific locations within the racks 104. In some embodiments, the placement of the specimen containers 102 in the racks 104 may serve to physically sort, the specimen containers 102 per pre-established sorting patterns. In some embodiments, the sorting may place like specimen containers together. In some embodiments, the sorting may place specimen containers containing specimens undergoing like tests together. In some embodiments, the sorting may be performed via software wherein one or more of the programs 118C know the locations in the racks 104 of like ones of the specimen containers 102 and/or specimen containers 102 containing specimens undergoing like tests.

The LIS 124 will know the locations of the specimen containers 102 and may direct the laboratory diagnostics system 100 to transport specific ones of the specimen containers 102 to specific modules and/or instruments based on tests that are to be performed on the specimen containers 102. Decisions on which specimen containers 102 are to be transported to specific modules 108 and/or instruments 110 may include determining which modules 108, including modules in the instruments 110, are available to perform the ordered tests.

Should an error occur with the I/O loader 140, the robot 144, and/or the components 142 (e.g., a barcode reader), the laboratory diagnostics system 100 may not operate efficiently or may be forced to shut down. For example, if the specimen containers 102 cannot be sorted or the labels 222 on the specimen containers 102, 202 cannot be read, the LIS 124 may not be able to generate instructions to cause the modules 108 and/or the instruments 110 to perform the tests described herein. In other situations, should the I/O loader 140 become overwhelmed, such as with a large number of specimen containers 102, testing may be delayed while the specimen containers 102 are sorted as described herein.

Some of the modules 108, including the modules in the instruments 110, will now be described. In some embodiments, one or more of the modules 108, 130, 132, 136 may be or may include a desealer configured to deseal the specimen containers 102. The desealer may remove caps (e.g., the cap 220) from the specimen containers 102 to provide access to the specimen 216. In some embodiments, components (e.g., imaging devices) in the desealer may read the identification information 2221 and may provide an update to the programs 118C and/or the LIS 124 to indicate the location and/or status of sample containers 102 undergoing the desealing operations. Thus, the LIS 124 and/or the programs 118C know which of the specimen containers 102 have been desealed and which of the specimen containers 102 are in the desealer.

In some embodiments, one or more of the modules 108, 130, 132, 136 may be a centrifuge configured to separate portions of the specimen 216 (FIGS. 2A-2C) by fractionation. In embodiments where the specimen is blood, the centrifuge separates the settled blood portion 216SB from the serum or plasma portion 216SP as shown in FIG. 2A. In some embodiments, one or more of the modules 108, 130, 132, 136 may be or include a quality check module that inspects the specimens and/or the specimen containers 102 prior to analyses. In some embodiments, the quality control module may check the specimen 216 for the presence of an interferent such as hemolysis, icterus, or lipemia (HIL), a blood clot, a bubble, or foam therein.

As described above, should the sorting capabilities of the I/O loader 140 be reduced or should the I/O loader 140 be overwhelmed, the system 100 may not function at capacity or may not function at all. For example, sorting functions in the I/O loader 140 may not function properly. In the embodiments described herein, one or more of the instruments 110 are configured to sort the specimen containers 102 to perform some of the sorting functions that would otherwise be performed in the I/O loader 140. Thus, the system 100 may function in the event the I/O loader 140 is unable to sort the specimen containers 102. In addition, or in the alternative, the performance of the system 100 may be enhanced by using one or more of the instruments 110 to perform secondary sorting.

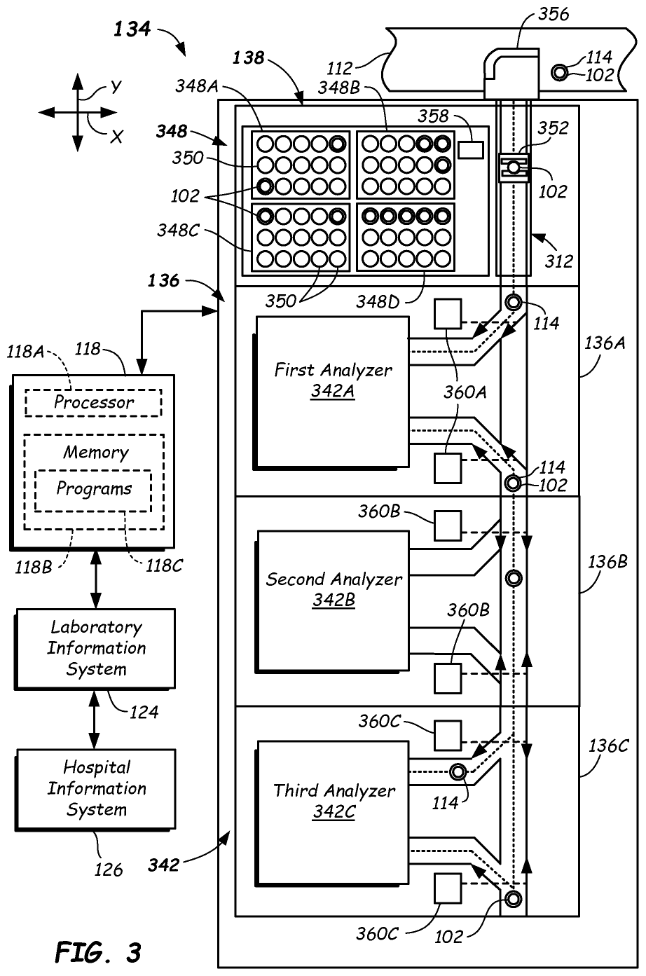

Additional reference is made to FIG. 3, which illustrates the third instrument 134, which may be identical to or similar to one or more of the instruments 110 (FIG. 1). In the embodiment of FIG. 3, the third instrument 134 includes three modules 136, which are referred to individually as the first module 136A, the second module 136B, and the third module 136C, as well as a specimen sorter 138. The modules 136 may include one or more analyzers 342 as described herein. For example, the first module 136A may include a first analyzer 342A that performs one or more first analyses on specimens (e.g., specimen 216—FIGS. 2A-2B), the second module 136B may include a second analyzer 342B, and the third module 136C, may include a third analyzer 342C. In some embodiments, one or more of the analyzers 342 may be devices that process specimens and/or the specimen containers 102. Examples of the devices that process specimens and/or the specimen containers 102 include quality check modules, centrifuges, decappers, aliquoters, and other devices described herein.

The third instrument 134 includes the specimen sorter 138 coupled to or otherwise incorporated into the third instrument 134. For example, in some embodiments, the specimen sorter 138 may be one of the modules 136 of the third instrument 134. In some embodiments, the specimen sorter 138 may be an individual module or device located directly adjacent the third instrument 134. The specimen sorter 138 may provide for transport of specimen containers 102 and/or specimens (e.g., specimen 216—FIGS. 2A-2B) to one or more of the modules 136 within the third instrument 134. As described herein, the specimen sorter 138 may sort specimens into at least first group and a second group. In some embodiments, the first group of specimens are to be analyzed by at least one of the one or more modules 136 and the second group of specimens are not to be analyzed by any of the modules 136.

The specimen sorter 138 may include a plurality of racks 348 into which the specimen containers 102, and thus, the specimens, may be sorted. In some embodiments, the racks 348 are resident in the specimen sorter 138. In other embodiments, the racks 348 may be external to the specimen sorter 138, but within the reach of a robot of the specimen sorter 138. In the embodiment of FIG. 3, the specimen sorter 138 includes four racks 348, which are referred to individually as a first rack 348A, a second rack 348B, a third rack 348C, and a fourth rack 348D. Each of the racks 348 may include a plurality of holders 350 (a few labelled) configured to hold the specimen containers 102. For example, each of the holders 350 may hold a single specimen container (e.g., specimen container 202—FIGS. 2A-2C). Holders 350 may include one or more springs to securely hold the specimen containers 102 in a defined upright orientation and location. In some embodiments, the specimen sorter 138 may include a robot 352 that is configured to move the specimen containers 102 into and out of specific ones of the holders 350. In some embodiments, the robot 352 may be a gantry robot that may be configured to move at least in an X-direction and a Y-direction to access the holders 350. The robot 352 may also be configured to plunge toward and away from the holders 350 to access and place the specimen containers in the holders 350 in a Z-direction.

The third instrument 134 may be directly proximate the system track 112 or the third instrument 134 may have access to the system track 112 via the robot 352 or other means. In some embodiments, a diverter device 356, which may be a moveable member, may be coupled to the third instrument 134 or the specimen sorter 138 and may divert specimen containers 102 into and/or out of the third instrument 134 or the specimen sorter 138, as is commanded. The diverter device 356 may be coupled to a transport system 312 that is configured to transport the specimen containers 102 throughout the third instrument 134. In some embodiments, the transport system 312 may be or may include a track. The robot 352 may be configured to move the specimen containers 102 from the transport system 312 to the racks 348 and to move the specimen containers 102 from the racks 348 to the transport system 312. In some embodiments, the robot 352 may remove the specimen containers 102 from the carriers 114 on the track to move only the specimen containers 102 to the holders 350.

In some embodiments, the specimen sorter 138 may include a reader 358, such as a barcode reader or an imaging device, configured to read identification information (e.g., identification information 2221—FIGS. 2A-2B) on the labels (e.g., label 222—FIGS. 2A-2B) on the specimen containers 102. In some embodiments, the reader 358 may be configured to read the labels as the specimen containers 102 are transported on the transport system 312. For example, the reader 358 may be located proximate the transport system 312. In some embodiments, the robot 352 may be configured to move the specimen containers 102 proximate the reader 358 wherein the reader 358 is configured to read the labels in response to the specimen containers 102 being proximate the reader 358.

Both the reader 358 and the robot 352 may be in communication with the computer 118 and/or the LIS 124. Thus, data generated by the reader 358 may be transmitted to the computer 118 and/or the LIS 124. Instructions for moving the robot 352 may be generated by one or more of the programs 118C and may be transmitted to the robot 352 to move the specimen containers 102 to specific locations, such as specific ones of the holders 350 and/or the transport system 312. One or more of the programs 118C or the LIS 124 may process the data generated by the reader 358. Accordingly, the programs 118C and/or the LIS 124 will know which specimens and/or specimen containers 102 are located in the specimen sorter 138. In some embodiments, the programs 118C and/or the LIS 124 will know into which of the holders 350 and racks 348 specific ones of the specimen containers 102 are located.

As described above, the specimen sorter 138 may sort the specimens (e.g., specimen containers 102) into specific groups as described herein. In some embodiments, the specimens may be physically sorted (e.g., grouped) into individual ones of the racks 348. For example, specimens of a first type may be placed into the first rack 348A and specimens of a second type may be placed into the second rack 348B. In some embodiments, the specimens may be electronically sorted. For example, the LIS 124 and/or one or more of the programs 118C may identify the locations in the holders 350 of at least a first group and a second group of specimens.

As shown in FIG. 3, the transport system 312 may enable transport of the specimen containers 102 to at least one of the modules 136. In some embodiments, diverters may divert specific ones of the specimen containers 102 and/or specimens into specific ones of the analyzers 342 for analyses (e.g., testing). In the embodiment of FIG. 3, a first diverter 360A in or associated with the first module 136A may divert specimen containers 102 into or out of the first analyzer 342A. A second diverter 360B in or associated with the second module 136B may divert specimen containers 102 into or out of the second analyzer 342B. A third diverter 360C in or associated with the third module 136C may divert specimen containers 102 into or out of the third analyzer 342C.

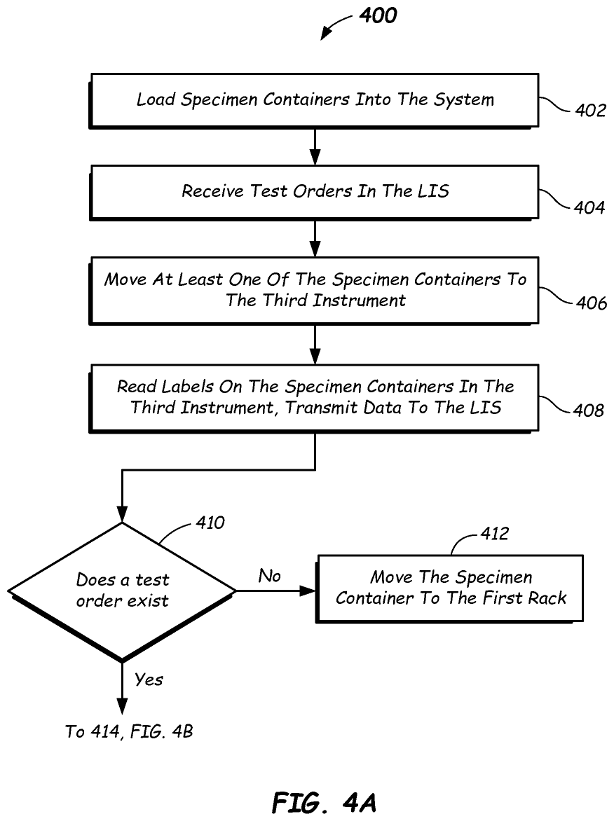

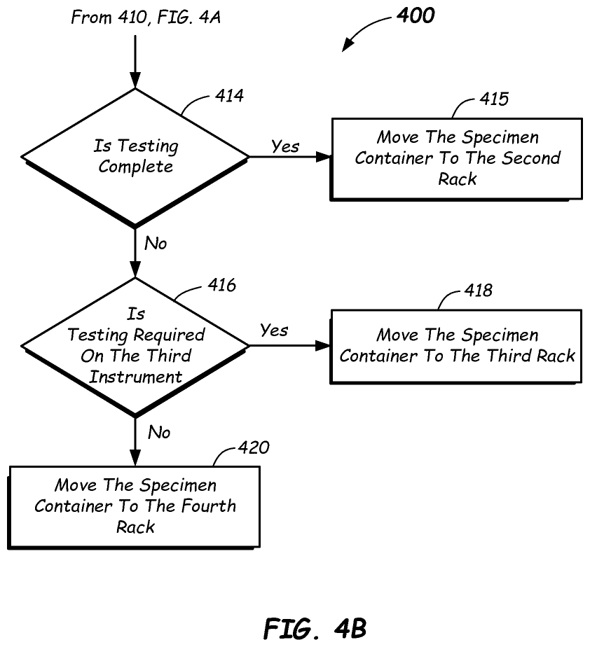

Additional reference is made to FIGS. 1 and 4A-4B to describe the operation of the system 100. FIGS. 4A-4B is a flowchart showing a method 400 of operating the system 100 with respect to the third instrument 134. In block 402 of the method 400, specimen containers 102 are loaded into the system 100. For example, the specimen containers 102 may be loaded into the I/O loader 140. Specific ones or all of the specimen containers 102 may then be placed onto the system track 112. For example, the robot 144 may move the specimen containers 102 onto the system track 112.

In block 404 of the method 400, test orders are received in the LIS 124. In some embodiments, the LIS 124 may be integral with the computer 118, so the test orders are received in the computer 118. The test orders indicate tests that are to be performed on the specimens within the specimen containers 102. The LIS 124 and/or the programs 118C may generate instructions that route certain specimen containers to certain ones of the modules 108 and/or the instruments 110 depending on the specific tests that are to be performed. Optionally, logic in the I/O loader 140 may generate instructions that route certain specimen containers 102.

The method 400 includes, in block 406, moving at least one of the specimen containers 102 to the third instrument 134. In some embodiments, specimens within the specimen containers 102 moved to the third instrument 134 may have undergone at least one test in one or more of the instruments 110 and/or one or more of the modules 108 before being moved to the third instrument 134. In some embodiments, one or more of the specimens and/or the specimen containers 102 moved to the third instrument 134 have undergone a process, such as desealing, quality check, and/or centrifuging before being received at the third instrument 134.

The method 400 includes, in block 408, reading the labels (e.g., label 222—FIGS. 2A-2B) on the specimen containers 102 and transmitting the data generated by the reading to the LIS 124. As described above, the LIS 124 may be implemented in the computer 118, so the data generated by the reading may be transmitted to the computer 118. For example, the robot 352 may move the specimen containers 102 proximate the reader 358 so that the reader 358 may read labels or indicia on the specimen containers 102 and transmit data generated by the reading to the LIS 124 and/or the computer 118.

Processing proceeds to decision block 410 where a determination is made as to whether a test order exists for a specimen that had the label read. For example, software in the LIS 124 and/or the programs 118C determines whether a test order exists for the specimen located in the specimen container 102. If no test order exists, processing proceeds to 412 where the specimen container may be moved to the first rack 348A. In the embodiment of FIG. 3, all the specimen containers 102 containing specimens with no test orders may be grouped in the first rack 348A. When test orders are received for specimens in the first rack 348A, the corresponding specimen containers may be moved to specific instruments and/or modules designated for the testing. If no test order is received for a specimen container in the first rack 348A after a pre-selected period of time, the specimen container may be removed from the system 100.

If a test order exists as determined in decision block 410, processing proceeds to decision block 414 where a determination is made as to whether testing on the specimen is complete. If testing is complete for the specimen as determined in decision block 414, the specimen container 102 may be moved to the second rack 348B as shown in 415 or the specimen container 102 may be removed from the system 100. For example, the specimen container 102 and other specimen containers 102 having specimens having completed tests may be grouped in the second rack 348B where they are awaiting removal from the system 100. In some embodiments, the LIS 124 or the programs 118C may cause storage of the specimen containers 102 in the second rack 348B until space exists on the system track 112 to move the specimen containers 102 to the I/O loader 140 where the specimen containers 102 may be removed from the system 100. In some embodiments, the specimen containers are stored or grouped in the second rack 348B may be removed from the third instrument 134 and/or the system 100.

If the determination of decision block 414 determines that the testing on the specimen in the specimen container 102 is not complete, processing proceeds to decision block 416 where a determination is made as to whether testing is required in the third instrument 134. For example, the LIS 124 or the programs 118C may determine whether tests are to be performed by one or more of the modules 136 in the third instrument 134. In some embodiments, the inquiry of decision block 416 may determine if any processes, such as processes to the specimen container (e.g., decapping) or the specimen (e.g., centrifuging), are to be performed by any of the modules 136 in the third instrument 134.

If the outcome of decision block 416 is positive, processing proceeds to 418 where the specimen container is moved to the third rack 348C. For example, the LIS 124 and/or the programs 118C may generate instructions that cause the robot 352 to move the specimen container 102 to the third rack 348C. In this embodiment, the third rack 348C holds specimen containers of specimens requiring testing and/or processing on one or more of the modules 136 in the third instrument 134. The LIS 124 and/or the programs 118C may generate instructions that move the specimen container 102 to one or more of the modules 136 for testing and/or processing when such modules are available.

If the outcome of decision block 416 is negative, processing proceeds to block 420 where the specimen container is moved to the fourth rack 348D. For example, the LIS 124 and/or the programs 118C may generate instructions that cause the robot 352 to move the specimen container 102 to the fourth rack 348D. The fourth rack 348D may be configured to hold specimen containers that require testing on one or more of the modules 108 and/or other ones of the instruments 110. The specimen containers in the fourth rack 348D may be held in the fourth rack 348D until the modules 108 and/or other ones of the instruments 110 that are to perform the testing are available. At such time, the LIS 124 and/or the programs 118C may generate instructions that cause the robot 352 to move the specimen containers 102 from the fourth rack 348D.

The system 100 may use other sorting schemes than the sorting scheme described in the method 400. In some embodiments, other ones of the instruments 110 may include specimen sorters, thus, the sorting schemes described herein and other sorting schemes may be used in conjunction with the other instruments. In some embodiments, the system 100 may have 20 or more, 30 or more, 40 or more, or even 50 or more modules 108 and/or instruments 110. A plurality of the instruments in the system 100 may include specimen sorters identical to similar to the specimen sorter 138. Accordingly, the system 100 may provide many redundant specimen sorting modules.

In some embodiments, an instrument with or associated with a specimen sorter may be an individual or a standalone device. Such instruments may not be coupled to other modules or devices by a system track. In such embodiments, the sorting as described above with reference to the third instrument 134 may be performed using the standalone instrument. In such embodiments, racks, such as the racks 348 may be removable after the specimen containers 102 are sorted into the racks 348. Racks 348 may be moved elsewhere for processing and/or testing of the specimen containers 102 therein.

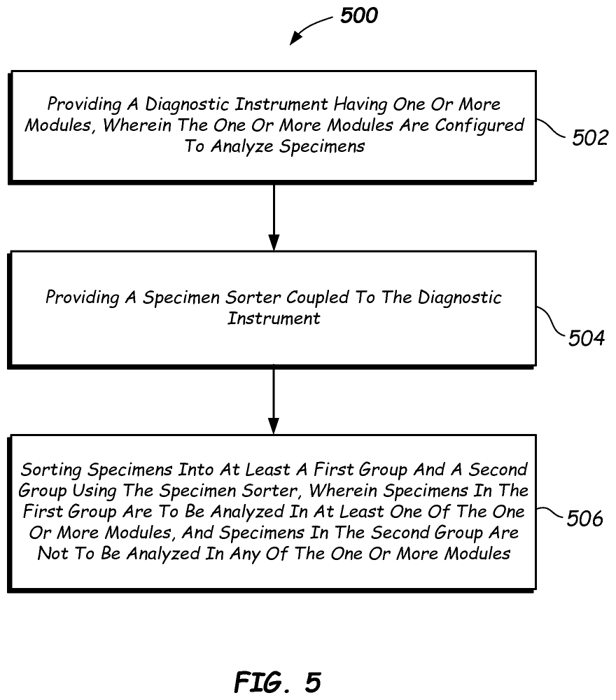

Reference is now made to FIG. 5, which is a flowchart illustrating a method 500 of operating a diagnostic instrument (e.g., instruments 110). The method 500 includes, in block 502, providing a diagnostic instrument (e.g., third instrument 134) having one or more modules (e.g., modules 136), wherein the one or more modules are configured to analyze specimens (e.g., specimen 216). The method 500 includes, in block 504, providing a specimen sorter (e.g., specimen sorter 138) coupled to the diagnostic instrument (e.g., third instrument 134). The method 500 includes, in block 506, sorting specimens into at least a first group and a second group using the specimen sorter, wherein specimens in the first group are to be analyzed in at least one of the one or more modules, and specimens in the second group are not to be analyzed in any of the one or more modules.

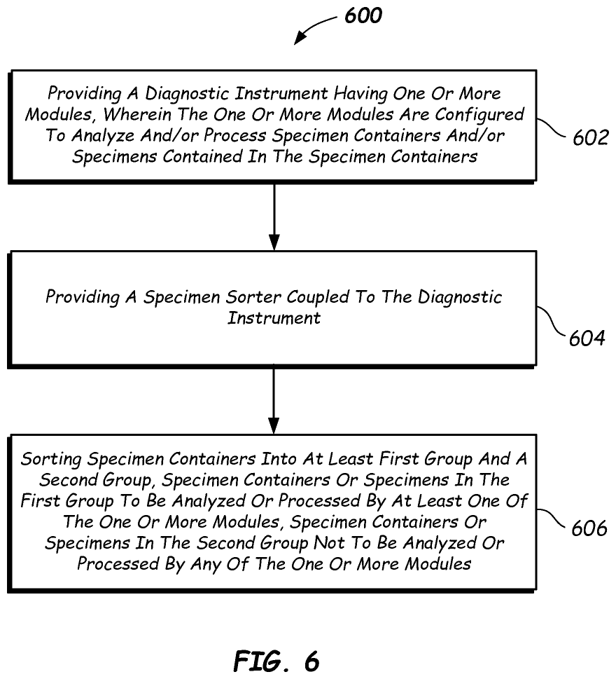

Reference is now made to FIG. 6, which is a flowchart illustrating a method 600 of operating a diagnostic instrument (e.g., instruments 110). The method 600 includes, in block 602, providing a diagnostic instrument (e.g., third instrument 134) having one or more modules (e.g., modules 136), wherein the one or more modules are configured to analyze and/or process specimen containers (e.g., specimen containers 102) and/or specimens (e.g., specimen 216) contained in the specimen containers. The method 600 includes, in block 604, providing a specimen sorter (e.g., specimen sorter 138) coupled to the diagnostic instrument. The method 600 includes, in block 606, sorting specimen containers into at least first group and a second group, specimen containers or specimens in the first group to be analyzed or processed by at least one of the one or more modules, specimen containers or specimens in the second group not to be analyzed or processed by any of the one or more modules.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure but, to the contrary, to cover all modifications, equivalents, and alternatives falling within the scope of the claims.

What is claimed is:

1. A method of operating a diagnostic instrument, comprising:
providing a diagnostic instrument having one or more modules, wherein the one or more modules are configured to analyze specimens;
providing a specimen sorter coupled to the diagnostic instrument; and
sorting specimens into at least a first group and a second group using the specimen sorter, wherein specimens in the first group are to be analyzed in at least one of the one or more modules, and specimens in the second group are not to be analyzed in any of the one or more modules.

2. The method of claim 1, comprising moving specimens in the first group to at least a first rack.

3. The method of claim 1, comprising moving specimens in the second group to at least a second rack.

4. The method of claim 1, comprising moving specimens in the first group to at least a first rack that is resident at the specimen sorter.

5. The method of claim 1, comprising moving specimens in the second group to at least a second rack that is resident at the specimen sorter.

6. The method of claim 1, wherein providing the specimen sorter comprises providing a specimen sorter configured as one of the one or more modules.

7. The method of claim 1, comprising receiving data from a location external to the diagnostic instrument, the data indicating whether at least one of the specimens is to be sorted into the first group or the second group, wherein the sorting is in response to the data.

8. The method of claim 1, comprising receiving data from a laboratory information system, the data indicating whether at least one of the specimens is to be sorted into the first group or the second group, wherein the sorting is in response to the data.

9. The method of claim 1, comprising sorting specimens into a third group, specimens in the third group to be analyzed by one or more modules external to the diagnostic instrument.

10. The method of claim 1, comprising sorting specimens into a fourth group, specimens in the fourth group not requiring further analyses.

11. The method of claim 1, comprising:
providing a reader coupled to the specimen sorter; and
reading information from a label of a specimen container containing a specimen.

12. The method of claim 11, wherein the sorting is performed at least partially in response to the reading.

13. The method of claim 1, comprising:
providing a transport system interconnecting the specimen sorter and at least one of the one or more modules; and
moving specimens in the first group by way of the transport system.

14. The method of claim 1, wherein the one or more modules are configured to determine a concentration of at least one analyte in the specimens.

15. The method of claim 1, wherein the one or more modules are configured to determine a presence of at least one analyte in the specimens.

16. A method of operating a diagnostic instrument, comprising:
providing a diagnostic instrument having one or more modules, wherein the one or more modules are configured to analyze and/or process specimen containers and/or specimens contained in specimen containers;
providing a specimen sorter coupled to the diagnostic instrument; and
sorting specimen containers into at least a first group and a second group, specimen containers or specimens in the first group to be analyzed or processed by at least one of the one or more modules, specimen containers or specimens in the second group not to be analyzed or processed by any of the one or more modules.

17. The method of claim 16, wherein the one or more modules are configured to determine a concentration of at least one analyte in the specimens.

18. The method of claim 16, wherein the one or more modules are configured to determine a presence of at least one analyte in the specimens.

19. A diagnostic instrument, comprising:
one or more modules;
a specimen sorter configured to sort specimens into at least a first group and a second group, wherein specimens in the first group are to be analyzed by at least one of the one or more modules, and specimens in the second group are not to be analyzed by any of the one or more modules; and
a transport system interconnecting the specimen sorter and at least one of the one or more modules, the transport system being configured to move specimens in the first group to at least one of the one or more modules.

20. The diagnostic instrument of claim 19, wherein the transport system is configured to move specimens in the second group from the diagnostic instrument.
